(19) United States
(12) Patent Application Publication
(10) Pub. No.: US 2020/0396997 A1
(43) Pub. Date: Dec. 24, 2020

(54) A STABLE AGROCHEMICAL COMPOSITION

(71) Applicant: UPL LTD, Haldia (IN)

(72) Inventors: Dev Varta Mukherjee, Mumbai (IN); Shiv Kumar Sharma, Mumbai (IN); Jaidev Rajnikant Shroff, Dubai (AE); Vikram Rajnikant Shroff, Dubai (AE)

(21) Appl. No.: 16/979,290

(22) PCT Filed: Mar. 1, 2019
(86) PCT No.: PCT/IB2019/051658

§ 371 Date: Sep. 9, 2020

(30) Foreign Application Priority Data
Mar. 15, 2018 (IN) 201831009604

(51) Int. Cl. A01N 43/40; A01N 25/10; A01N 57/28; A01N 25/14

(52) U.S. Cl. CPC A01N 43/40; A01N 25/14; A01N 57/28; A01N 25/10

(57) ABSTRACT

The present invention discloses a stable agrochemical composition comprising at least one chloronicotinyl compound; and a polyoxyethylene/polyoxypropylene block copolymeric chain, wherein said polyoxyethylene/polyoxypropylene block copolymeric chain is end-capped with alkyl groups. The invention also provides a process for preparing said stable agrochemical composition, a method of controlling unwanted pests by applying an agrochemically effective amount of the stable agrochemical compositions and and its use as an insecticidal composition according to the present invention.

### FIELD OF THE INVENTION

The present invention relates to a stable agrochemical composition. The invention more specifically relates to a stable agrochemical composition comprising moisture sensitive agrochemicals.

### BACKGROUND AND THE PRIOR ART

Stability of moisture sensitive agrochemical is difficult as it exhibits undesirable changes when exposed to a moist environment, during the time of preparation and also upon storage. Since manufacturing of agrochemical compositions cannot always be conducted in an environment having a low humidity, there can be significant degradation during the various production operations, prior to packaging of the product. After packaging, stability of the products can be affected by transfer of moisture through packaging components, as well as reactions involving components of the package atmosphere. These factors become responsible for introduction of extrinsic moisture to the composition. Due to normal fluctuations in the moisture content of the atmosphere, storage of moisture sensitive agrochemicals become challenging.

The organophosphorus compound, Acephate (N-(Methoxy-methylsulfanylphosphoryl) acetamide) is a very desirable insecticide in the agrochemical world. Acephate is more stable in acidic conditions and least stable in alkaline conditions. However, acephate is highly sensitive to moisture and not stable in conventional pesticidal formulations. Also, acephate absorbs moisture from the surroundings and transmit the same in the composition that triggers degradation of co-formulants or other actives present in the composition.

The Chloronicotinyl insecticides like Acetamiprid ((E)-N′-[(6-chloro-3-pyridyl)methyl]-N-cyano-N-methylacetamidine) is also an important insecticide for soil and foliar application. It is stable in the neutral or slightly acidic medium and can gradually hydrolyze when pH is 9 at 45° C. Imidacloprid (1-[(6-chloropyridin-3-yl) methyl]-N-nitro-4, 5-dihydroimidazol-2-amine), another chloronicotinyl insecticide is stable to hydrolysis in acidic or neutral conditions, but hydrolysis increases with increasing alkaline pH and temperature. Although, chloronicotinyl insecticides are not so moisture sensitive but often degrade when co-formulated with moisture-sensitive agrochemicals.

As an environment protection guideline to some countries for risk mitigation, composition comprising organophosphates (especially acephate) alone or with other active ingredients is to be packed and sold in water soluble pouch. Since acephate is toxic to mammals, water soluble pouch prohibits direct contact of acephate to the user.

Packaging of agrochemicals in water-soluble pouch offer many advantages, among them being the pre-measurement of the packet contents for a single use; reduction in the degree of inconvenience or hazard in using agrochemicals which are dusty or otherwise undesirable if allowed to come in physical contact with the user. Nevertheless, agrochemical compositions packed in water soluble pouch are relatively easy to handle during the mixing process and also results in decreased contamination of the environment.

Water soluble pouch are made of water-soluble thermoplastic films with an inherent moisture content of 6.0%-12.0%. It has been observed that water soluble pouch is affected by external factors such as temperature, pH and moisture. The water soluble pouch experience premature breakage when kept in high humidity place. Similarly, high temperature makes it brittle due to loss of inherent moisture.

Stability issue arises when organophosphates are formulated with chloronicotinyl compounds. They cannot be stored for a virtually long time because the two active components contained in the composition interact with each other, leading to the decomposition of the overall composition. The condition worsens further when such composition is packed in water soluble pouch. The organophosphorous compounds absorb moisture from water soluble pouch, adding it to the composition and accelerate degradation of chloronicotinyl compounds.

In past, researchers tried addressing the stability issues of organophosphorous compounds and chloronicotinyl compounds when they were formulated together.

US 20060008493 disclosed a synergistic composition comprising chloronicotinyl compound and organophosphorous compound. The compositions disclosed include a stabilizer, which though is able to impart limited stability and limited shelf life but there is a need to investigate and solve the problem of stability of such compositions, especially under moisture conditions.

U.S. Pat. No. 5,140,019 disclosed methods of prevention of decomposition of a combination of a compound comprising imidacloprid, an organophosphorous compound and compounds selected from polyethylene glycol, propylene glycol, ethylene glycol-propylene glycol co-polymer or a mixture of these compounds. However, the stability studies have been conducted in glass containers and in dark rooms which is different when compared with commercial scale storage conditions. Further no reference has been made in the invention with respect to stability in the presence of extrinsic moisture conditions.

Therefore, need exists to provide a composition of moisture sensitive organophosphorous compounds and chloronicotinyl compounds having storage stability in water soluble pouch and also the process of obtaining the stable composition.

### OBJECTS OF THE PRESENT INVENTION

One objective of the present invention is to provide a stable agrochemical composition of moisture sensitive agrochemicals, namely a chloronicotinyl compound and an organophosphorus compound and, which is stable while storing in water soluble pouch.

Another objective of the present invention is to provide a process of preparing a stable agrochemical composition of moisture sensitive agrochemicals, namely a chloronicotinyl compound and an organophosphorus compound which is stable in water soluble pouch.

Another objective of the present invention is to provide a storage stable agrochemical composition comprising of acetamiprid and acephate which has an improved shelf life while stored in water soluble pouch.

### SUMMARY OF THE INVENTION

In one aspect, the present invention provides a stable agrochemical composition comprising at least one chloronicotinyl compound; optionally at least one organophosphorous compound; and a polyoxyethylene/polyoxypropylene block copolymeric chain, wherein said polyoxyethylene/polyoxypropylene block copolymeric chain is end-capped with alkyl groups.

In another aspect, the present invention provides a stable agrochemical composition comprising;
(A) at least one chloronicotinyl compound;
(B) at least one organophosphorous compound; and
(C) a polyoxyethylene/polyoxypropylene block copolymeric chain
wherein said polyoxyethylene/polyoxypropylene block copolymeric chain is end-capped with alkyl groups.

In another aspect, the present invention provides a stable agrochemical composition comprising acetamiprid, and a polyoxyethylene/polyoxypropylene block copolymeric chain, wherein said polyoxyethylene/polyoxypropylene block copolymeric chain is end-capped with alkyl groups.

In accordance with the above objectives, the present invention provides a stable agrochemical composition comprising;
(A) acetamiprid;
(B) acephate; and
(C) a polyoxyethylene/polyoxypropylene block copolymeric chain,
wherein said polyoxyethylene/polyoxypropylene block copolymeric chain is end-capped with alkyl groups.

In accordance with the above objectives, the present invention provides a process for preparation of stable agrochemical composition comprising at least one chloronicotinyl compound, optionally at least one organophosphorous compound, and a polyoxyethylene/polyoxypropylene block copolymeric chain, wherein said polyoxyethylene/polyoxypropylene block copolymeric chain is end-capped with alkyl groups said process comprises the steps of:
1) premixing at least one active ingredient from chloronicotinyl compound or organophosphorous compound with polyoxyethylene/polyoxypropylene block copolymeric chain which is end-capped with alkyl groups mixed together to obtain a mixture;
2) optionally adding the mixture to at least another active ingredient from chloronicotinyl compound or organophosphorous compound and mixed for sufficient time to obtain a blend; and
3) subjecting the blend to extrusion to obtain granules.

In accordance with the above objectives, the present invention provides use of stable agrochemical compositions according to the present invention as pest control solution.

In accordance with the above objectives, the present invention further provides a method of controlling unwanted pests said method comprising applying an agrochemically effective amount of stable agrochemical compositions according to the present invention to the pests or to their locus.

Additional features and advantages of the present invention will be apparent from the detailed description that follows, which illustrates by way of example, the most preferred features of the present invention which are not to be construed as limiting the scope of the invention described herein.

### DETAILED DESCRIPTION OF THE INVENTION

As used herein the term ‘composition’ is used interchangeably with the term ‘formulation’ and is intended to refer to the stable wet granules intended to prevent damage of agricultural crops and its produce from insects and pests.

The term ‘moisture sensitive’ active ingredient refers to a compound having ability to absorb moisture and undergoes degradation.

As used herein, the term ‘degradation’ denotes loss of the active ingredient as a result of exposure to moisture.

Surprisingly, it has been found that, a stable composition comprising chloronicotinyl compounds can be prepared by adding polyethyleneoxy and polypropyleneoxy block copolymeric chain which are end-capped with alkyl groups. The resultant composition remains stable without any adverse influences of extrinsic moisture on the physical properties of the active ingredients in the composition.

It has been further found that, a stable composition comprising chloronicotinyl compounds and organophosphorous compound and can be prepared by adding polyethyleneoxy and polypropyleneoxy block copolymeric chain which are end-capped with alkyl groups. The resultant composition remains stable without any adverse influences of extrinsic moisture on the physical properties of the active ingredients in the composition.

The inventors of the present invention have found that the addition of polyoxyethylene/polyoxypropylene block copolymeric chain end-capped with alkyl groups to a composition comprising a moisture sensitive active ingredient, being a chloronicotinyl compound, and/or in combination with an organophosphorus compound, resulted in highly stable composition.

Without wishing to be bound by theory, the inventors in the present invention have surprisingly found, that addition of polyoxyethylene/polyoxypropylene block copolymeric chain end-capped with alkyl group to a composition of a moisture sensitive active ingredient such as chloronicotinyl compound, optionally in the presence of an organophosphorous compound, results in a stable composition.

In one aspect, the present invention provides a stable agrochemical composition comprising at least one chloronicotinyl compound; optionally atleast one organophosphorous compound; and a polyoxyethylene/polyoxypropylene block copolymeric chain, wherein said polyoxyethylene/polyoxypropylene block copolymeric chain is end-capped with alkyl groups.

In another aspect, the present invention provides a stable agrochemical composition comprising;
(A) atleast one chloronicotinyl compound;
(B) atleast one organophosphorous compound; and
(C) a polyoxyethylene/polyoxypropylene block copolymeric chain,
wherein said polyoxyethylene/polyoxypropylene block copolymeric chain is end-capped with alkyl groups.

In another aspect, the present invention provides a stable agrochemical composition comprising acetamiprid; and a polyoxyethylene/polyoxypropylene block copolymeric chain, wherein said polyoxyethylene/polyoxypropylene block copolymeric chain is end-capped with alkyl groups.

In an embodiment, the present invention provides a stable agrochemical composition comprising:
(A) acetamiprid;
(B) acephate; and
(C) a polyoxyethylene/polyoxypropylene block copolymeric chain,
wherein said polyoxyethylene/polyoxypropylene block copolymeric chain is end-capped with alkyl groups.

In an embodiment, the stable agrochemical composition comprises a chloronicotinyl compound.

In another embodiment, the chloronicotinyl compound may be selected from the group consisting of acetamiprid, imidacloprid, thiacloprid, thiamethoxam and combinations thereof.

The preferred chloronicotinyl compound are selected from acetamiprid, imidacloprid, thiacloprid or combinations thereof.

According to another embodiment of the present invention, the stable agrochemical composition comprising from about 0.1% to about 40% w/w and preferably from about 0.5% to about 30% w/w chloronicotinyl compound of the total weight of the stable agrochemical composition.

In a preferred embodiment of the present invention, the stable agrochemical composition comprises from about 0.5% to about 20% w/w chloronicotinyl compound of the total weight of the stable agrochemical composition.

In an embodiment, the stable agrochemical composition additionally comprises an organophosphorus compound.

In another embodiment, the organophosphorus compound may be selected from the group consisting of acephate, aspon, azinphos-methyl, carbofuran, carbophenothion, chlorfenvinphos, chlorpyrifos, coumaphos, crotoxyphos, crufomate, demeton, diazinon, dichlorvos, dicrotophos, dimethoate, dioxathion, disulfoton, EPN, ethion, ethoprop, famphur, fenamiphos, fenitrothion, fensulfothion, fenthion, fonofos, isofenfos, malathion, methamidophos, methidathion, methyl parathion, mevinphos, monocrotophos, metam sodium, naled, oxydemeton-methyl, parathion, phorate, phosalone, phosmet, phosphamidon, profenofos, temephos, TEPP, terbufos, tetrachlorvinphos, trichlorfon and combinations thereof.

The preferred organophosphorus compound may be selected from acephate, chlorpyrifos, profenophos, phosphomidon or mixtures thereof.

According to another embodiment of the present invention, the stable agrochemical composition comprises from about 0.1% to about 99% w/w, preferably about 0.1% to about 95% w/w, preferably about 0.5% to about 95% w/w and more preferably from about 10% to about 95% w/w organophosphorus compound of the total weight of the stable agrochemical composition.

In a preferred embodiment of the present invention, the stable agrochemical composition comprises from about 40% to about 90% w/w organophosphorus compound of the total weight of the stable agrochemical composition.

In an embodiment, the stable agrochemical composition comprises a polyoxyethylene/polyoxypropylene block copolymeric chain end-capped with one or more alkyl groups.

A polyoxyethylene/polyoxypropylene block copolymeric chain according to the invention would have one or both of the hydrogens of the hydroxyl groups removed and replaced with a different functional group. Preferably, the replacement functional group is a functional group that is less reactive than a hydroxyl group. More preferably the replacement functional group is an alkyl group (—CH₃, —C₂H₅ etc.) such that the resulting compound is capable of providing stability to the composition comprising moisture sensitive active ingredients.

According to another embodiment, the polyoxyethylene/polyoxypropylene block copolymeric chain, is end-capped with one or more alkyl groups comprising methyl group, ethyl group, propyl group and butyl group.

According to a preferred embodiment of the present invention the composition comprises an polyoxyethylene/polyoxypropylene block copolymeric chain, end-capped with methyl group.

According to another embodiment of the present invention, the stable agrochemical composition comprises from about 0.1% to about 30% w/w and preferably from about 0.1% to about 20% w/w and more preferably from about 0.2% to about 20% w/w polyoxyethylene/polyoxypropylene block copolymeric chain of the total weight of the stable agrochemical composition.

According to an embodiment, a stable agrochemical composition of the present invention comprises a chloronicotinyl compound, an organophosphorous compound and a polyoxyethylene/polyoxypropylene block copolymeric chain, end-capped with alkyl groups.

According to specific embodiments a stable agrochemical composition of the present invention may comprise from about 0.5% to about 30% w/w of chloronicotinyl compound, from about 0.1% to about 95% w/w of organophosphorous compound, from about 0.1% to about 20% w/w of a polyoxyethylene/polyoxypropylene block copolymeric chain, end-capped with alkyl groups.

According to an embodiment of the present invention, there is provided a stable agrochemical composition comprising acetamiprid, acephate and polyoxyethylene/polyoxypropylene block copolymeric chain, end-capped with alkyl groups.

According to specific embodiments a stable agrochemical composition of the present invention may comprise from about 0.5% to about 95% w/w of acephate, from about 0.1% to about 30% w/w of acetamiprid, from about 1.0% to about 20% w/w of a polyoxyethylene/polyoxypropylene block copolymeric chain, end-capped with alkyl groups.

According to specific embodiments a stable agrochemical composition of the present invention may comprise from about 89% w/w of acephate, from about 5% w/w of acetamiprid, from about 2.5% w/w of a polyoxyethylene) polyoxypropylene block copolymeric chain, end-capped with alkyl groups.

According to specific embodiments a stable agrochemical composition of the present invention may comprise from about 90% w/w of acephate, from about 5% w/w of acetamiprid, from about 1.0% w/w of a polyoxyethylene/polyoxypropylene block copolymeric chain, end-capped with alkyl groups.

According to specific embodiments a stable agrochemical composition of the present invention may comprise from about 90% w/w of acephate, from about 5% w/w of acetamiprid, from about 2.0% w/w of a polyoxyethylene/polyoxypropylene block copolymeric chain, end-capped with alkyl groups.

The present invention provides a process for preparation of the stabilized agrochemical composition comprising at least one chloronicotinyl compound, at least one organophosphorous compound, and a polyoxyethylene) polyoxypropylene block copolymeric chain, wherein said polyoxyethylene/polyoxypropylene block copolymeric chain is end-capped with alkyl groups.

According to an embodiment of the present invention, a process for the preparing a stable agrochemical composition comprises:
1) premixing at least one active ingredient from chloronicotinyl compound or organophosphorous compound with polyoxyethylene/polyoxypropylene block copolymeric chain which is end-capped with alkyl groups mixed together to obtain a mixture;
2) optionally adding the mixture to atleast another active ingredient from chloronicotinyl compound or organophosphorous compound and mixed for sufficient time to obtain a blend; and
3) subjecting the blend to extrusion to obtain granules.

According to an embodiment of the present invention, a process for the preparing a stable agrochemical composition comprises premixing chloronicotinyl compound with polyoxyethylene) polyoxypropylene block copolymeric chain which is end-capped with alkyl groups.

According to an embodiment of the present invention, a process for the preparing a stable agrochemical composition comprises premixing the chloronicotinyl compound with polyoxyethylene/polyoxypropylene block copolymeric chain which is end-capped with alkyl groups, and optionally adding an organophosphorous compound.

According to an embodiment, the blend is obtained by mixing the active ingredients according to the process described in the invention for a sufficient time from about 1 min to about 24 hours.

According to an embodiment of the present invention, a process for the preparing a stable agrochemical composition comprises:
1) premixing at least one chloronicotinyl compound with polyoxyethylene/polyoxypropylene block copolymeric chain which is end-capped with alkyl groups mixed together to obtain a mixture;
2) optionally adding the mixture to atleast one organophosphorous compound and mixed for sufficient to obtain a blend; and
3) subjecting the blend to extrusion to obtain granules.

According to another embodiment of the present invention, the process for the preparing a stable agrochemical composition comprises pre-mixing chloronicotinyl compound with polyoxyethylene) polyoxypropylene block copolymeric chain end-capped with alkyl group along with other necessary formulation auxiliaries to obtain a mixture.

According to another embodiment of the present invention, the process of obtaining blend of mixture of chloronicotinyl compound with polyoxyethylene/polyoxypropylene block copolymeric chain, end-capped with alkyl group and organophosphorous compound and the process of extrusion may be performed separately, sequentially or simultaneously.

According to another embodiment of the present invention, other solid formulations can also be obtained from a blend of mixture of chloronicotinyl compound with other formulation ingredients and organophosphorous compound.

According to an embodiment of the present invention, a process for the preparing a stable agrochemical composition comprises:
1) premixing chloronicotinyl compound with polyoxyethylene; polyoxypropylene block copolymeric chain which is end-capped with alkyl group and mixed together to obtain a mixture;
2) adding the mixture to organophosphorous and mixing it for sufficient time to obtain a blend;
3) subjecting the blend to extrusion to obtain granules.

According to an embodiment of the present invention, a process for the preparing a stable agrochemical composition comprises:
1) premixing acetamiprid with polyoxyethylene polyoxypropylene block copolymeric chain which is end-capped with alkyl group and mixed together to obtain a mixture,
2) adding the mixture to acephate and mixing it for sufficient time to obtain a blend,
3) subjecting the blend to extrusion to obtain granules.

In an embodiment, the process of the present invention comprises additional conventional steps, which may be necessary but not crucial to achieve the advantages of the present invention.

According to another embodiment of the present invention, in the process for preparation of the stable agrochemical composition, the extruded granules can further be subjected to drying in a suitable device.

Examples of suitable device for drying that may be selected from but not limited to air flow band dryers, stirring dryers, fluidized bed dryers, vibration dryers and bed-type dryers. The fluidized bed dryer is preferred.

According to another embodiment of the present invention, in the process for preparation of the stable agrochemical composition, the extruded granules, thus obtained, are preferably tested for required quality specifications. Once the granules pass quality specification, they are preferably filled and packed in desired packing.

In an embodiment, the composition of the present invention can be formulated as a solid composition including, but not limited to, dust, powder, granules, pellets, tablets, dry flowable, wettable powder or water dispersible granules.

In an embodiment, it is preferred to prepare the agrochemical composition according to the invention as Wettable Granules (WG).

In an embodiment, it is preferred to prepare the agrochemical composition according to the invention as Water Dispersible Granules (WDG).

In an embodiment, the present invention provides a stable water dispersible granular composition comprising from about 0.5% to about 95% w/w of acephate, from about 0.1% to about 30% w/w of acetamiprid, from about 1.0% to about 20% w/w of a polyoxyethylene/polyoxypropylene block copolymeric chain, end-capped with alkyl groups; and remaining amounts of an agrochemically acceptable excipient or carrier.

In an embodiment, the composition of the present invention is a stable water dispersible granular composition, wherein the active ingredients are combined with various carriers.

The stable agrochemical compositions of the present invention may further comprise one or more ingredient selected from pH stabilizers, additives, dispersants, wetting agents, fillers, surfactants, anticaking agents, preservatives, biocides, antifoaming agents, humectants, colorants and other formulation aids.

The pH stabilizer may be selected from sodium dihydrogen orthophoshphate dihydrate, disodium hydrogen orthophosphate anhydrous, tertiary polyhydroxy amine, cationic quaternary ammonium compound containing propylene glycol, dimethylglucamine, trifunctional amine, hydroxypropyl methyl cellulose, styrene-divinylbenzene-copolymer with sulphonic acid groups in H-form, diethanolamine, monoethanolamine, triethanolamine or mixtures thereof.

The additive may be selected from the group comprising of hydrophobic silica, hydrophilic silica, hydrophobic fumed silica (Aerosil R 972, Cabosil T S 610, HDK, Aerosil R 812), hydrophilic fumed silica, silica gels, silicates, talc, kaolin, montmorillonite, attapulgite, pumice, sepiolite, bentonite, limestone, lime, chalk, clay, dolomite, diatomaceous earth, calcite, calcium sulfate, magnesium sulfate, magnesium sulfate, magnesium oxide, sand, ammonium sulfate, ammonium phosphate, ammonium nitrate, ureas, cereal meal, tree bark meal, wood meal, nutshell meal, and cellulose powders.

The dispersants may be selected from ionic and nonionic dispersants to enable disintegration of granules in water with ease, such as salts of polystyrene sulphonic acids, salts of polyvinylsulphonic acids, salts of naphthalenesulphonic acid/formaldehyde condensates, salts of condensates of naphthalenesulphonic acid, phenolsulphonic acid and formaldehyde, and salts of lignosulphonic acid, polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone and copolymers of (meth)acrylic acid and (meth)acrylic esters, furthermore alkyl ethoxylates and alkylarylethoxylates ethoxylated alkylarylphosphated and sulphated ester. The preferred dispersing agents include derivative of ethoxylates of vegetable oil or a mixture of one or more of these; or styrene acrylic polymers or mixtures thereof.

The wetting agents may be selected from soaps; salts of aliphatic monoesters of sulphuric acid including but not limited to sodium lauryl sulphate; sulfoakylamides and salts thereof including but not limited to N-methyl-N-oleoyltaurate Na salt; akylarylsulfonates including but not limited to akylbenzenesulfonates; akylnaphthalenesulfonates and salts thereof and salts of ligninsulfonic acid.

In some embodiment fillers may be selected from insoluble fillers and soluble fillers.

In an embodiment, fillers may be selected preferably from precipitated silica and diatomaceous earth kaolin.

In an embodiment, humectants may be selected from glycerol or sugar syrups, such as corn syrup, which is obtained from maize.

In an embodiment, suitable antifoams may, preferably be, silicones, long-chain alcohols and salts of fatty acids.

Suitable colorants (for example in red, blue and green) are, preferably, pigments, which are sparingly soluble in water, and dyes, which are water-soluble. Examples are inorganic coloring agents (for example iron oxide, titanium oxide, and iron hexacyanoferrate) and organic coloring agents (for example alizarin, azo and phthalocyanin coloring agents).

In an embodiment, the stable agrochemical composition of the present invention may be optionally mixed together with other insecticides, attractants, sterilants, bactericides, acaracides, nematicides, fungicides, growth regulators, herbicides, fertilizers and mixtures thereof.

The premix of chloronicotinyl compound with polyoxyethylene/polyoxypropylene block copolymeric chain which is end-capped with alkyl groups prevents direct interaction of chloronicotinyl compound with organophosphorous compound in the composition which in turn prevents chloronicotinyl compound from deterioration in the presence of moisture sensitive organophosphorous compound.

The composition of the present invention enjoys all the advantages discussed above, making it beneficial from an economic aspect and a handling aspect and shows a very good performance during application. As depicted in the examples, the composition of the present invention demonstrates good stability.

In accordance with the above objectives, the present invention provides use of stable agrochemical composition comprising at least one chloronicotinyl compound, optionally at least one organophosphorous compound and polyoxyethylene/polyoxypropylene block copolymeric chain which is end-capped with alkyl group, as a pesticide.

In an embodiment, the stable agrochemical composition according; to the present invention is used as an insecticide.

In an embodiment, the present invention provides a method of controlling unwanted pests, said method comprising applying an agrochemical composition according to the present invention to the pests or to their locus.

Thus, in an aspect, the present invention may provide methods of controlling insect pests at a locus, said method comprising application of an insecticidally effective amount of a composition comprising:
(A) at least one chloronicotinyl compound;
(B) optionally at least one organophosphorous compound; and
(C) polyoxyethylene/polyoxypropylene block copolymeric chain,
wherein said polyoxyethylene/polyoxypropylene block copolymeric chain is end-capped with alkyl groups.

In an embodiment, the present invention may provide methods of controlling insect pests at a locus, said method comprising application of an insecticidally effective amount of a composition comprising:
(A) atleast one chloronicotinyl compound;
(B) atleast one organophosphorous compound; and
(C) a polyoxyethylene/polyoxypropylene block copolymeric chain,
wherein said polyoxyethylene/polyoxypropylene block copolymeric chain is end-capped with alkyl groups.

In an embodiment, the present invention may provide methods of controlling insect pests at a locus, said method comprising application of an insecticidally effective amount of a composition comprising:
(A) acetamiprid;
(B) acephate; and
(C) a polyoxyethylene/polyoxypropylene block copolymeric chain,
   wherein said polyoxyethylene/polyoxypropylene block copolymeric chain is end-capped with alkyl groups,

In an embodiment, the present invention may provide methods of controlling insect pest such as those belonging to Lepidopteran, Coleoptran, Dipteran, Hemipteran classes of insecticides.

Inventors of the present invention succeeded in preparing stable agrochemical composition by careful combination of at least one chloronicotinyl compound, at least one organophosphorous compound and polyoxyethylene/polyoxypropylene block copolymeric chain end-capped with alkyl group and process of preparing the same. The optimum concentration of the actives as well as formulation ingredients which led to the stable WG formulation has been arrived at by the experiments as exemplified below.

### EXPERIMENTAL EXAMPLES

The following examples illustrate the basic methodology and versatility of the invention.

### Example 1

Acetamiprid and Acephate w/w WG was Prepared as Follows:

TABLE 1

| Composition | Quantity (% w/w) |
|---|---|
| Acetamiprid Technical (99.0% purity) | 5.5 |
| Acephate Technical (98.0% purity) | 88.50 |
| EO/PO block copolymer end-capped with methyl | 2.5 |
| group | |
| pH stabilizer | 2.0 |
| Hydrophobic silica | q.s. |
| Total | 100 |

1) Mixing
a) Weighed quantity of pre-ground acetamiprid technical was loaded into a mixer to which weighed quantity of EO/PO block copolymer end-capped with methyl group was added and mixed until a homogeneous mixture was obtained. Further hydrophobic fumed silica was added and mixed to obtain homogeneous free flowing powder. To this powder, pH stabilizer was added and continued blending to obtain a mixture.
b) Weighed quantity of acephate technical was separately taken in a blender. The mixture obtained in step 1(a) was added to it and blended thoroughly for about 30 min to obtain a homogeneous blend of all the ingredients.

2. Extrusion:

The homogeneous blend thus obtained in step 1 was extruded using extruder with 1.0 mm diameter sieve to obtain granules and kept for drying at room temperature. Therefore, the storage stable agrochemical composition of acetamiprid and acephate is obtained according to the process disclosed in this invention.

### Example 2

Acetamiprid and Acephate WG w/w was Prepared as Follows:

| Composition | Quantity (% w/w) |
|---|---|
| Acetamiprid Technical (99.0% purity) | 5.5 |
| Acephate Technical (98.0% purity) | 89.5 |
| EO/PO block copolymer end-capped with methyl | 1.0 |
| group | |
| pH Stabilizer | 2.0 |
| Hydrophobic silica | q.s. |
| Total | 100 |

The WG composition including acetamiprid, acephate hydrophobic silica, EO/PO block copolymer end-capped with methyl group and pH stabilizer in a given ratio shown above was prepared as per the process of Example 1.

### Example 3

Acetamiprid and Acephate w/w WG was Prepared as Follows:

| Composition | Quantity (% w/w) |
|---|---|
| Acetamiprid Technical (99% purity) | 5.5 |
| Acephate Technical (98% purity) | 89.5 |
| Non End-capped EO/PO block copolymer | 2.0 |
| pH Stabilizer | 2.0 |
| Hydrophobic silica | q.s. |
| Total | 100 |

The WG composition including acetamiprid, acephate, hydrophobic silica, non end-capped EO/PO block copolymer and pH stabilizer in a given ratio shown above was prepared as per the process of Example 1.

### Example 4

Acetamiprid WDG was Prepared as Follows:

| Composition | Quantity (% w/w) |
|---|---|
| Acetamiprid Technical (99.0% purity) | 21 |
| EO/PO block copolymer end-capped with methyl | 1.5 |
| group | |
| pH Stabilizer | 2.0 |
| Hydrophobic silica | QS |
| Total | 100 |

The WG composition including acetamiprid, hydrophobic silica, EO/PO block copolymer end-capped with methyl group and pH stabilizer in a given ratio shown above was prepared as per the process of Example 1.

### Example 5

Imidacloprid WDG was Prepared as Follows:

| Composition | Quantity (% w/w) |
|---|---|
| Imidacloprid Technical (99.0% purity) | 71 |
| EO/PO block copolymer end-capped with methyl | 1.5 |
| group | |
| pH Stabilizer | 2.0 |
| Clay | QS |
| Total | 100 |

The WG composition including Imidacloprid, clay, EO/PO block copolymer end-capped with methyl group and pH stabilizer in a given ratio shown above was prepared as per the process of Example 1.

### Example 6

Thiamethoxam WDG was Prepared as Follows:

| Composition | Quantity (% w/w) |
|---|---|
| Thimethoxam Technical (96% purity) | 26.2 |
| EO/PO block copolymer end-capped with methyl | 1.5 |
| group | |
| pH Stabilizer | 2.0 |
| Hydrophobic silica | Q S |
| Total | 100 |

The WG composition including Thiamethoxam, hydrophobic silica, EO/PO block copolymer end-capped with methyl group and pH stabilizer in a given ratio shown above was prepared as per the process of Example 1.

### Example 7

Thiacloprid WDG was Prepared as Follows:

| Composition | Quantity (% w/w) |
|---|---|
| Thiacloprid Technical (98% purity) | 51 |
| pH Stabilizer | 2.0 |
| Hydrophobic silica | QS |
| Total | 100 |

The WG composition including thiacloprid, hydrophobic silica and pH stabilizer in a given ratio shown above was prepared as per the process of Example 1.

### Example 8

Dichlorvos+Imidacloprid WDG was Prepared as Follows:

| Composition | Quantity (% w/w) |
|---|---|
| Dichlorvos Technical (95% Purity) | 26.4 |
| Imidacloprid Technical (98% purity) | 5.1 |
| EO/PO block copolymer end-capped with methyl | 1.1 |
| group | |
| pH Stabilizer | 2.0 |
| Hydrophobic silica/Clay | QS |
| Total | 100 |

The WG composition including Dichlorvos, Imidacloprid, silica, EO/PO block copolymer end-capped with methyl group and pH stabilizer in a given ratio shown above was prepared as per the process of Example 1.

### Example 9

Malathion+Thiamethoxam WDG was Prepared as Follows:

| Composition | Quantity (% w/w) |
|---|---|
| Malathiaon Technical (95% purity) | 26.33 |
| Thiamethoxam Technical (96% purity) | 5.20 |
| EO/PO block copolymer end-capped with methyl | 1.5 |
| group | |
| pH Stabilizer | 1.5 |
| Clay | QS |
| Total | 100 |

The WG composition including Malathion, Thiamethoxam, clay, EO/PO block copolymer end-capped with methyl group and pH stabilizer in a given ratio shown above was prepared as per the process of Example 1.

### Example 10

Methyl-Parathion+Imidacloprid WDG was Prepared as Follows:

| Composition | Quantity (% w/w) |
|---|---|
| Methyl-Parathion Technical (80% purity) | 62.5 |
| Imidacloprid Technical (98.0% purity) | 1.54 |
| EO/PO block copolymer end-capped with methyl | 1.5 |
| group | |
| pH Stabilizer | 2.0 |
| Hydrophobic silica | QS |
| Total | 100 |

The WG composition including Methyl-Parathion, Imidacloprid, EO/PO block copolymer end-capped with methyl group, hydrophobic silica and pH stabilizer in a given ratio shown above was prepared as per the process of Example 1.

### Example 11

Chlorpyrifos+Thiacloprid WDG was Prepared as Follows:

| Composition | Quantity (% w/w) |
|---|---|
| Chlorpyrifos Technical (97% purity) | 20.7 |
| Thiacloprid Technical (98% purity) | 10.21 |
| EO/PO block copolymer end-capped with methyl | 1.5 |
| group | |
| pH Stabilizer | 2.0 |
| Hydrophobic silica | QS |
| Total | 100 |

The WG composition including Chlorpyrifos, Thiacloprid, hydrophobic silica, EO/PO block copolymer end-capped with methyl group and pH stabilizer in a given ratio shown above was prepared as per the process of Example 1.

Study of Chloronicotinyl Compositions Having EO/PO Block Copolymer End-Capped with Methyl Group and without Having EO/PO Block Polymer End-Capped with Methyl Group

| | 7 Days AHS | | 14 Days AHS | |
|---|---|---|---|---|
| | | Without | | Without |
| | End-capped EO/PO | End-capped EO/PO | End-capped EO/PO | End-capped EO/PO |
| | block copolymer | block copolymer | block copolymer | block copolymer |
| Ingredients | (Example 4) | (Example 7) | (Example 4) | (Example 7) |
| Acetamiprid Technical | 20.5 | 20.45 | 20.2 | 18.8 |
| Moisture Content | 0.25 | 0.59 | 0.24 | 0.62 |
| % Degradation | 0.97 | 5.55 | 1.2 | 15.2 |
| Thiacloprid Technical | 50.25 | 50.1 | 50.12 | 49.56 |
| Moisture Content | 1.11 | 1.15 | 1.23 | 1.34 |
| % Degradation | 0.58 | 5.1 | 0.93 | 7.91 |

The composition described in Example-4 (having EO/PO block copolymer end-capped with methyl group) prepared according to the process disclosed in the present invention was tested against the composition described in Example-7 (having no EO/PO block copolymer). The objective of study was to determine the effect of EO/PO block copolymer end-capped with alkyl group on chloronicotinyl compounds in preventing degradation of the compositions as well as the overall stability to the compositions.

It was observed that the composition comprising EO/PO block copolymer end-capped with methyl group remained quite stable in both 7 days AHS as well as 14 days AHS. Degradation observed for acetamiprid in 7 days AHS was 0.97% and in 14 days AHS was 1.2%. Similarly, degradation observed for Thiacloprid in 7 days AHS was 0.58% and in 14 days AHS was 0.93%. The overall moisture content of said composition was also found to be controlled throughout the study.

Strikingly, contrasting observations were made for the composition prepared without using end-capped EO/PO block copolymer. Extensive degradation observed for acetamiprid in 7 days AHS (5.55%) and in 14 days AHS (15.2%). Similarly, enormous degradation observed for Thiacloprid in 7 days AHS with 5.1% degradation and in 14 days AHS with 7.91% 20 degradation. This composition thus failed to pass the AHS stability test. It was thus surprising that the presence of the alkyl end-capped polymer of the present invention, even in small quantities, contributed significantly to the chemical stability of the chloronicotinyl compounds in the compositions of the present invention. The only difference between the compared compositions was the presence and EO/PO block copolymer end-capped with methyl group.

Comparative Study of the Compositions with EO/PO Block Copolymer End-Capped with Methyl Group and Non-End Capped EO/PO Block Polymer

| | 7 Days AHS | | 14 Days AHS | |
|---|---|---|---|---|
| | | Non | | Non |
| | End-capped EO/PO | End-capped EO/PO | End-capped EO/PO | End-capped EO/PO |
| | block copolymer | block copolymer | block copolymer | block copolymer |
| Ingredients | (Example 1) | (Example 3) | (Example 1) | (Example 3) |
| Moisture Content | 0.11 | 0.56 | 0.12 | 0.71 |
| Acephate | 88.16 | 86.75 | 88.00 | 86.40 |
| Acetamiprid | 5.321 | 5.07 | 5.227 | 4.78 |
| % Degradation | 0.64/0.93 | 1.5/7.98 | 1.02/2.57 | 1.92/13.24 |
| (Acephate/ | | | | |
| Acetamiprid) | | | | |

The composition described in Example-1 (having EO/PO block copolymer end-capped with methyl group) prepared according to the process disclosed in the present invention was tested against the composition described in Example-3 (having non-alkyl end-capped EO/PO block copolymer). The objective of study was to determine the effect EO/PO block copolymer end-capped with alkyl group in preventing degradation of active ingredients and to impart overall stability to the composition.

It was observed that the composition comprising EO/PO block copolymer end-capped with methyl group remained quite stable in both 7 days AHS as well as 14 days AHS. Degradation observed for acephate in 7 days AHS was 0.64% and in 14 days AHS was 1.02%. Similarly, degradation observed for acetamiprid in 7 days AHS was 0.93% and in 14 days AHS was 2.57%. The overall moisture content of said composition was also found to be controlled throughout the study.

Strikingly, contrasting observations were made for the composition comprising non end-capped EO/PO block copolymer. While degradation observed for acephate in 7 days AHS was 1.5 and in 14 days AHS was 1.92; enormous degradation observed for acetamiprid in 7 days AHS with 7.98% and in 14 days AHS with 13.24% degradation. This composition thus failed to pass the AHS stability test. It was thus surprising that the presence of the alkyl end-capped polymer of the present invention, even in small quantities, contributed significantly to the chemical stability of the compositions of the present invention. The only difference between the compared compositions was the presence and absence of the alkyl end-capping. Therefore, the surprisingly improved chemical stability of the compositions of the present invention could be attributed solely to the alkylic end-capping of the EO/PO polymeric chain, which was unexpected and surprising. The overall moisture content of said composition was also found to be more than 0.5% which is supposed to contribute to overall degradation of the composition.

Stability Study of Active Ingredients in Various Storage Conditions

| | | | |
|---|---|---|---|
| Active | AMB | 14 D AHS | % Degradation |

Without Packing

| | | | |
|---|---|---|---|
| Acetamiprid | 5.403 | 5.267 | 2.5 |
| Acephate | 88.59 | 87.81 | 0.75 |

Packed in Water Soluble Pouch

| | | | |
|---|---|---|---|
| Acetamiprid | 5.403 | 5.163 | 4.4 |
| Acephate | 88.59 | 87.13 | 1.29 |

The composition described in Example-1 prepared according to the process disclosed in the present invention was tested to determine the stability of active ingredients when subjected to various storage conditions. Degradation of active ingredients was calculated at ambient conditions and in 14 days AHS at 54° C. for the composition kept as unpacked and as packed in water soluble pouch. Acetamiprid and Acephate both found to be stable in unpacked as well as when packed in the water soluble pouch.

Stability of Active Ingredients Observed in Real Time Study

| Active Ingredients | Ambient | 19 Month Real Time |
|---|---|---|
| Acetamiprid A. I. | 5.11 | 4.99 |
| Degradation | | 2.31 |
| Acephate A. I. | 88.11 | 85.03 |
| Degradation | | 3.50 |

The composition prepared in Example-2 according to the process disclosed in the present invention is kept for real time study to observe degradation pattern of active ingredients. The composition was kept for 19 months in ambient conditions. Acetamiprid and Acephate found to be very stable with 3.5% and 2.31% degradation respectively. This resulted into an overall stable agrochemical composition.

Therefore, the stable agrochemical composition prepared according to the process disclosed in the present invention exhibited good stability. The extremely sensitive acephate and chloronicotinyl compound can be formulated together according to the process disclosed in the present invention and same can be stored safely in water soluble pouch as well as trilaminated pouch without undesirable degradation of actives. The instant invention is more specifically explained by above example. However, it should be understood that the scope of the present invention is not limited by the examples in any manner. It will be appreciated by any person skilled in this art that the present invention includes aforesaid examples and further can be modified and altered within the technical scope of the present invention.

1. A stable agrochemical composition comprising at least one chloronicotinyl compound and a polyoxyethylene/polyoxypropylene block copolymeric chain, wherein said polyoxyethylene/polyoxypropylene block copolymeric chain is end-capped with an alkyl groups.

2. The stable agrochemical composition as claimed in claim 1, wherein said chloronicotinyl compound is selected from the group consisting of acetamiprid, imidacloprid, thiacloprid, thiamethoxam and combinations thereof.

3. The stable agrochemical composition as claimed in claim 1, wherein said chloronicotinyl compound is acetamiprid.

4. The stable agrochemical composition as claimed in claim 1, wherein, said chloronicotinyl compound is present in an amount from about 0.1% to about 40% w/w of the total weight of the composition.

5. The stable agrochemical composition as claimed in claim 4, wherein said chloronicotinyl compound is present in an amount from about 0.5% to about 20% w/w of the total weight of the composition.

6. The stable agrochemical composition as claimed in claim 1, wherein said polyoxyethylene/polyoxypropylene block copolymeric chain is end-capped with alkyl groups selected from the group consisting of a methyl group, an ethyl group, a propyl group, and a butyl group.

7. The stable agrochemical composition as claimed in claim 1, wherein said polyoxyethylene/polyoxypropylene block copolymeric chain is end-capped with methyl group.

8. The stable agrochemical composition as claimed in claim 1, wherein said polyoxyethylene/polyoxypropylene block copolymeric chain is present in an amount from about 0.1% to about 30% w/w of the total weight of the composition.

9. The stable agrochemical composition as claimed in claim 1, wherein; said polyoxyethylene/polyoxypropylene block copolymeric chain is present in an amount from about 0.2% to about 20% w/w of the total weight of the composition.

10. The stable agrochemical composition as claimed in claim 1, further comprising at least one organophosphorous compound.

11. The stable agrochemical composition as claimed in claim 10, wherein said organophosphorous compound is acephate.

12. A stable agrochemical composition comprising at least one chloronicotinyl compound, at least one organophosphorous compound, and a polyoxyethylene/polyoxypropylene block copolymeric chain, wherein said polyoxyethylene/polyoxypropylene block copolymeric chain is end-capped with an alkyl group.

13. The stable agrochemical composition as claimed in claim 12, wherein, said organophosphorous compound is selected from the group consisting of acephate, aspon, azinphos-methyl, carbofuran, carbophenothion, chlorfenvinphos, chlorpyrifos, coumaphos, crotoxyphos, crufomate, demeton, diazinon, dichlorvos, dicrotophos, dimethoate, dioxathion, disulfoton, EPN, ethion, ethoprop, famphur, fenamiphos, fenitrothion, fensulfothion, fenthion, fonofos, isofenfos, malathion, methamidophos, methidathion, methyl parathion, mevinphos, monocrotophos, metam sodium, naled, oxydemeton-methyl, parathion, phorate, phosalone, phosmet, phosphamidon, profenofos, temephos, TEPP, terbufos, tetrachlorvinphos, trichlorfon and combinations thereof.

14. The stable agrochemical composition as claimed in claim 12, wherein said organophosphorous compound is acephate.

15. The stable agrochemical composition as claimed in claim 12, wherein said composition comprises from about 0.1% to about 95% w/w of the organophosphorous compound, from about 0.5% to about 30% w/w of the chloronicotinyl compound and from about 0.1% to about 20% w/w of the polyoxyethylene/polyoxypropylene block copolymeric chain, end-capped with alkyl groups, all based on the total weight of the composition.

16. The stable agrochemical composition as claimed in claim 12, wherein, said composition comprises acephate and.

17. The stable agrochemical composition as claimed in claim 12, wherein said composition comprises from about 0.5% to about 95% w/w of acephate, from about 0.1% to about 30% w/w of acetamiprid and from about 1.0% to about 20% w/w of to the polyoxyethylene/polyoxypropylene block copolymeric chain, end-capped with alkyl groups, all based on the total weight of the composition.

18. The stable agrochemical composition as claimed in claim 1, in the form of water dispersible granules.

19. A stable water dispersible granular composition comprising from about 0.5% to about 95% w/w of acephate, from about 0.1% to about 30% w/w of acetamiprid, and from about 1.0% to about 20% w/w of a polyoxyethylene/polyoxypropylene block copolymeric chain, end-capped with alkyl groups, all based on the total weight of the composition.

20. The composition as claimed in claim 19, further comprising one or more ingredient selected from pH stabilizers, additives, dispersants, wetting agents, fillers, surfactants, anticaking agents, preservatives, biocides, antifoaming agents, humectants, colorants and formulation aids.

21. A process for preparation of a stable agrochemical composition comprising at least one chloronicotinyl compound, optionally at least one organophosphorous compound, and a polyoxyethylene/polyoxypropylene block copolymeric chain, wherein said polyoxyethylene/polyoxypropylene block copolymeric chain is end-capped with alkyl groups, said process comprises the steps of
1) premixing the at least one chloronicotinyl compound or the organophosphorous compound with polyoxyethylene/polyoxypropylene block copolymeric chain which is end-capped with alkyl groups mixed together to obtain a mixture;
2) optionally adding the mixture to at least another active chloronicotinyl compound or organophosphorous compound and mixing to obtain a blend; and
3) subjecting the blend to extrusion to obtain granules.

22. The process for preparing stable agrochemical composition as claimed in claim 21, wherein, said blend is obtained by conducting step 1) and 2) for a period from about 1 min to about 24 hours.

23. The process for the preparing stable agrochemical composition as claimed in claim 21, wherein steps 1), 2) and 3) are performed separately sequentially or simultaneously.

24. The process for preparing stable agrochemical composition as claimed in claim 21, wherein said chloronicotinyl compound is acetamiprid, and said process comprises steps of:
1) premixing the acetamiprid with the polyoxyethylene/polyoxypropylene block copolymeric chain which is end-capped with alkyl group to obtain a mixture;
2) adding the mixture to an organophosphorus compound that is acephate and mixing for sufficient time to obtain a blend; and
3) subjecting the blend to extrusion to obtain granules.

25. (canceled)

26. A method of controlling unwanted pests, said method comprising applying an agrochemically effective amount the stable agrochemical composition of claim 1 to the pests or to their locus.

27. The method of claim 26, wherein the unwanted pests are insect pests.
